(19) United States
(12) Patent Application Publication
(10) Pub. No.: US 2005/0204521 A1
(43) Pub. Date: Sep. 22, 2005

(54) High-strength, wear resistant swingbolt support hook and hook-and-swingbolt fastener assembly including a high-strength, wear resistant support hook

(76) Inventors: Francis W. Hughto-Delzer, Endwell, NY (US); Herbert M. Swan III, Vestal, NY (US); Dale Zimmer, Apalachin, NY (US); Peter M. Ziolkowski, Apalachin, NY (US)

Correspondence Address: Louis J. Franco;Law Office of Louis J. Franco - Lunenburg, 250 Arbor Street, Lunenburg, MA, 01462, US

(21) Appl. No.: 10/803,182

(22) Filed: Mar. 16, 2004

(51) Int. Cl. E05C 19/06

(52) U.S. Cl. 24/569

(57) ABSTRACT

A swingbolt hook includes a base having rear and front surfaces and extending along a base axis between first and second ends. Depending from the base is a swingbolt catch adapted for selective retaining engagement with the hook catch of a swingbolt. The swingbolt catch has base and distal ends and first and second opposed surfaces. Each of the first and second surfaces extends laterally between left and right sides and (i) the first surface extends between the front surface of the base and the distal end of the swingbolt catch and is adjacent to, and joined through a first transition region with, the front surface of the base and (ii) the second surface extends between the rear surface of the base and the distal end of the swingbolt catch and is joined, through a second transition region, with the rear surface of the base. The first and second surfaces are oriented to one another such that, as viewed into a cross-sectional plane passing through the first and second surfaces and between the left and right sides of the swingbolt catch, the first and second surfaces extend along, respectively, first and second catch-surface axes that converge away from the base such that the swingbolt catch increases in thickness between the first and second surfaces with increased proximity to the base.

### STATEMENT OF UNITED STATES GOVERNMENT RIGHTS IN THE INVENTION

This invention was made with U.S. Government support under contract N00019-97-C-0147 awarded by the United States Navy. The U.S. Government has certain rights in this invention.

### BACKGROUND

1. Field

Although not so limited in its utility or scope, implementations of the present invention are particularly well suited for tool-less, selectively releasable fastening of the housings of electronics units to trays, shelves and other frameworks carried aboard aircraft, ships and railroads, for example.

2. Brief Description of Illustrative Environments and Related Art

Hook-and-swingbolt fastener assemblies are widely employed in various industries including, for example, the selectively releasable securement of ship-board electronics and avionics housings. In a typical implementation, an electronics housing or “box” includes a wall with an exterior surface to which is mounted one or more swingbolt hooks. Each swingbolt hook includes a mounting portion or base that is fastened, adhered or otherwise secured to the housing and a curved catch portion that extends outwardly from the base. Depending from the tray shelf or other framework to which the housing is to be secured is a swingbolt adapted for cooperative securing engagement with each of a selected number of swingbolt hooks depending from the housing.

As shown in the examples of FIGS. A and Bi, a typical swingbolt includes an elongated rod having first and second ends and is externally threaded along at least a portion of its length between the first and second ends. The first end is pivotably anchored to the tray or other framework to which the housing is to be secured by a clevis, for example. Annularly disposed about the rod is a hook catch which is most commonly configured as a hook-engaging cup that, when not secured in contacting engagement with a hook, is linearly translatable along the rod axis. Situated between the second end of the rod and the cup is an internally threaded swingbolt nut threadably received about the threaded portion of the rod.

The housing of an electronics unit, for instance, is removably mounted in a vehicle by placing the housing on a tray or shelf. Each swingbolt hook of a selected number of swingbolt hooks is aligned for engagement with a swingbolt depending from the tray. Once aligned with a swingbolt hook, a swingbolt is swung into a position (FIG. A) that facilitates the engagement of the annular interior surface of the cup with the swingbolt catch of the hook. The cup and swingbolt catch are then retained in securing engagement by threadably advancing the nut toward the first end of the rod to urge and retain the interior cup surface in engagement with the swingbolt catch. Although the nut can be of a type that is advanced with a tool such as a wrench, swingbolt assemblies are typically designed so as to obviate the need for tools. Accordingly, the nut is either incorporated into a knob or the rod carries a separate knob selectively engageable with the nut. In the particular examples of FIGS. A and B, inwardly projecting flanges depend from an inside knob wall for selective, torque-applying engagement with outwardly projecting flanges depending from the nut.

Hook-and-swingbolt fastener systems have experienced some failures, particularly when used in vehicles subjected to highly turbulent or otherwise harsh environments such as military aircraft. A common point of failure has been in the swingbolt hooks and, more particularly, in the wear and bending and/or breaking off of swingbolt catches from the bases of hooks. Swingbolt hook failures can result in the destruction of very expensive equipment and injuries to personnel.

Accordingly, there exists a need for an improved swingbolt hook less susceptible to failure.

### SUMMARY

In various alternative embodiments, a hook-and-swingbolt fastener system adapted for selectively coupling first and second objects comprises a swingbolt including (i) an elongated rod having a first end pivotably mountable to a first object and a second end longitudinally opposite the first end, (ii) a set of external threads extending along at least a portion of the rod, (iii) a hook catch slidably retained by the rod and adapted for longitudinal translation along the rod, and (iv) an internally threaded nut situated between the second end of the rod and the hook catch such that the nut can be selectively caused to exert a force against the hook catch in the direction of the first end of the rod.

A swingbolt hook adapted for selective cooperative coupling with the swingbolt includes an base having rear and front surfaces and extends longitudinally along a base axis between first and second ends, the rear surface being adapted for mounting in contacting engagement with a surface of the second object (e.g., a framework, a wall or an electronic unit housing). In a typical embodiment, the base axis is defined so as to extend along a mounting plane that, for example, when the hook is mounted to a second object surface, is parallel to a plane defined by the object surface to which the hook is mounted. Depending from the base is a swingbolt catch having base and distal ends and first and second opposed surfaces. Each of the first and second surfaces extends laterally between left and right sides of the swingbolt catch. The first surface furthermore extends between the front surface of the base and the distal end of the swingbolt catch and is adjacent to, and joined through a first transition region with, the front surface of the base. The second surface extends between the rear surface of the base and the distal end of the swingbolt catch and is joined, through a second transition region, with the rear surface of the base.

The first and second surfaces of the swingbolt catch are oriented to one another such that, as viewed into a first cross-sectional plane passing through the first and second surfaces and between the left and right sides of the swingbolt catch, the first and second surfaces extend along, respectively, first and second catch-surface axes that converge away from the base such that the swingbolt catch increases in thickness between the first and second surfaces with increased proximity to the base. In various versions, the first catch-surface axis defines, with the first base axis, a first angle that is one of (i) 90-degrees and (ii) acute and the second catch-surface axis defines, with the first base axis, a second angle that is more acute than the first angle. Still additional alternative versions are configured such that, as viewed into a second cross-sectional plane passing through the first and second surfaces and the left and right sides of the swingbolt catch, at least one of (i) the first surface of the swingbolt catch is convex and (ii) the second surface of the swingbolt catch is concave.

In order to resist wear and/or corrosion, various embodiments are at least partially coated with a wear-resistant coating such as, by way of non-limiting example, nickel plate, Teflon®, or chrome.

Although hook-and-swingbolt fasteners generally facilitate the rapid and convenient releasable securement of one structure to another without the use of tools, typical embodiments of the present invention are particularly well suited for releasably mounting electronic equipment to customized frameworks carried aboard transport vehicles such as, by way of non-limiting example, commercial and military aircraft; ocean-going vessels including ships and submarines; and railroad engines and cars. Examples of the frameworks to which electronic equipment is secured include shelves, racks and trays. It will be appreciated that, although it is more typical for swingbolt hooks mounted to equipment unit housings to cooperatively engage swingbolts depending from the frameworks to which those unit housings are to be secured, implementations in which swingbolts are mounted to unit housings and swingbolt hooks are mounted to frameworks are also within the scope and contemplation of the invention.

The swingbolt and swingbolt hook cooperate such that, once they are generally aligned with one another along a common plane, for example, the swingbolt is swung into a position that facilitates the engagement of an interior surface of the hook catch with the swingbolt catch of the hook. The “common plane” is, for instance, a plane along which the rod of the swingbolt pivots. When the interior surface of the hook catch is placed in contacting engagement with the swingbolt catch and the nut is threadably advanced toward the first end of the rod so as to exert at least a predetermined minimum force against the hook catch, the swingbolt catch and hook catch are drawn into retaining engagement. Representative, non-limiting embodiments are more completely described and depicted in the following detailed description and the accompanying drawings.

### BRIEF DESCRIPTION OF THE DRAWINGS

FIG. A depicts an illustrative current hook-and-swingbolt fastener system;

FIGS. Bi and Bii depict front and right side views of an illustrative existing swingbolt hook;

FIG. Biii shows the swingbolt hook of FIGS. Bi and Bii fastened to a housing and a swingbolt pivotably mounted to a tray with the swingbolt hook and swingbolt cooperatively coupled to retain the housing and tray in fixed relative positions;

FIG. 1 depicts an illustrative hook-and-swingbolt fastener system wherein the swingbolt hook embodies aspects of the invention;

FIG. 2 shows a front view of an illustrative swingbolt hook;

FIG. 2A is a cross-sectional side view of the swingbolt hook depicted in FIG. 2;

FIG. 3 is side view of the hook of FIG. 2;

FIG. 3A is a front cross-section as viewed into a plane passing through the swingbolt catch of the hook in FIG. 3;

FIG. 4A shows an illustrative hook catch including a collar annularly disposed about the rod of a swingbolt and including a socket with an arcuate interior surface adapted for contacting engagement with the swingbolt catch of a swingbolt hook;

FIG. 4B is a side view of the hook catch of FIG. 4A in coupled engagement with the swingbolt catch of a swingbolt hook;

FIG. 4C depicts an alternatively configured illustrative hook catch including a collar annularly disposed about the rod of a swingbolt and including an arm extending outwardly from the collar to a distal end from which depends a tongue with a planar interior surface adapted for contacting engagement with the swingbolt catch of a swingbolt hook;

FIG. 4D is a side view of the hook catch of FIG. 4C in coupled engagement with the swingbolt catch of a swingbolt hook;

FIG. 5 depicts an alternative illustrative hook-and-swingbolt fastener system wherein the swingbolt hook embodies aspects of the invention;

FIG. 5A is a view into the cross-sectional plane V_{A} as indicated in FIG. 5;

FIG. 5B is a cross-sectional view of a swingbolt catch of rectangular cross section engaging the hook catch of swingbolt; and

FIG. 6 shows a swingbolt hook similar to the swingbolt hook of FIGS. 2A through 3A with a wear-resistant coating.

### DETAILED DESCRIPTION

The following description of various embodiments of a hook-and-swingbolt fastener assembly and of a hook adapted for selective coupling with a swingbolt is illustrative in nature and is therefore not intended to limit the scope of the invention or its application of uses.

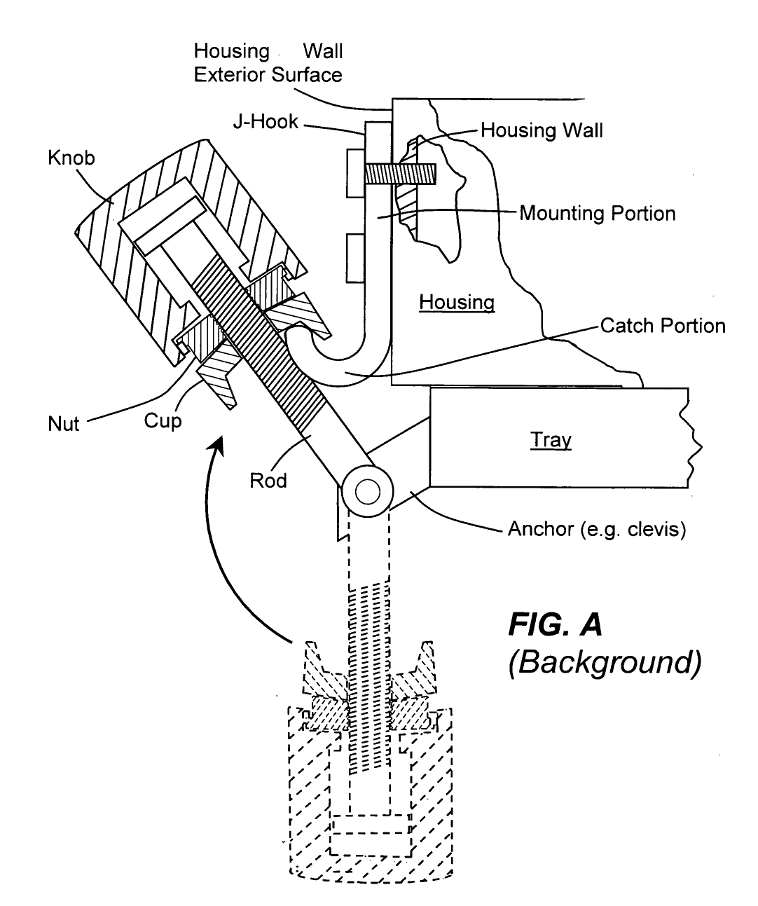

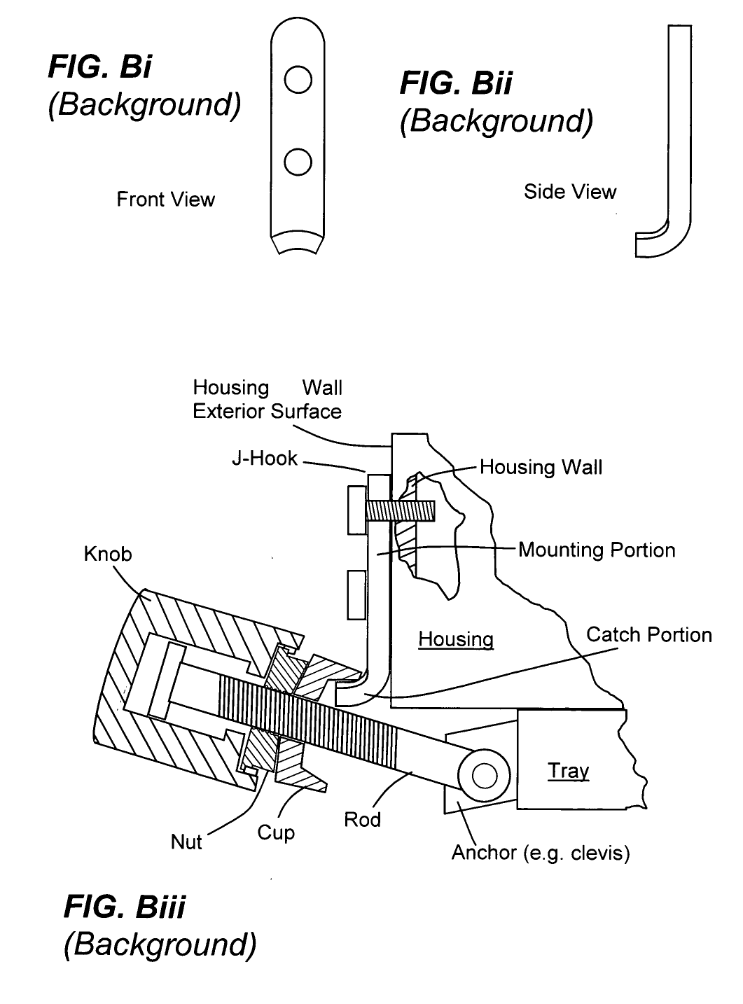

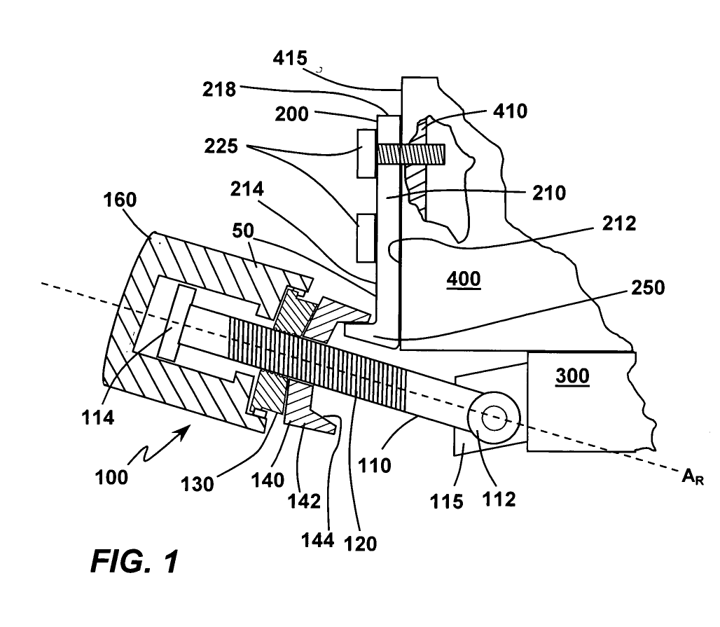

Referring to FIG. 1, two main components of a hook-and-swingbolt fastener system 50 are a swingbolt 100 and a swingbolt hook 200. The illustrative swingbolt 100 of FIG. 1 includes an elongated rod 110 extending along a rod axis A_{R} between a first end 112 and a second end 114. The first end 112 of the rod 110 is pivotally anchored to a shelf 300 by a clevis 115.

Extending at least partially between the first and second ends 112 and 114 of the rod 110 is a set of external threads 120 that threadably receives and retains a nut 130 for alternative threadable advancement toward and away from each of the first and second ends 112 and 114. A hook catch 140 is slidably retained between the first end 112 of the rod 110 and the nut 130 such that the position of the nut 130 along the threads 120 limits the extent to which the hook catch 140 is slidable along the rod 110 toward to the second end 114 of the rod 110. The nut 130 is rotated about the threads 120 by a knob 160 that is selectively engageable with the nut 130.

Referring to FIGS. 1 and 2 through 3A, an illustrative swingbolt hook 200 adapted for selective coupling engagement with the swingbolt 100 includes a base 210 having rear and front surfaces 212 and 214 and extends longitudinally along a base axis A_{B} between first and second ends 216 and 218. The swingbolt hook 200, as shown in FIG. 1, is mounted by fasteners 225 to a housing 400 with the rear surface 212 of the base 210 in contacting engagement with the exterior surface 415 of the housing wall 410.

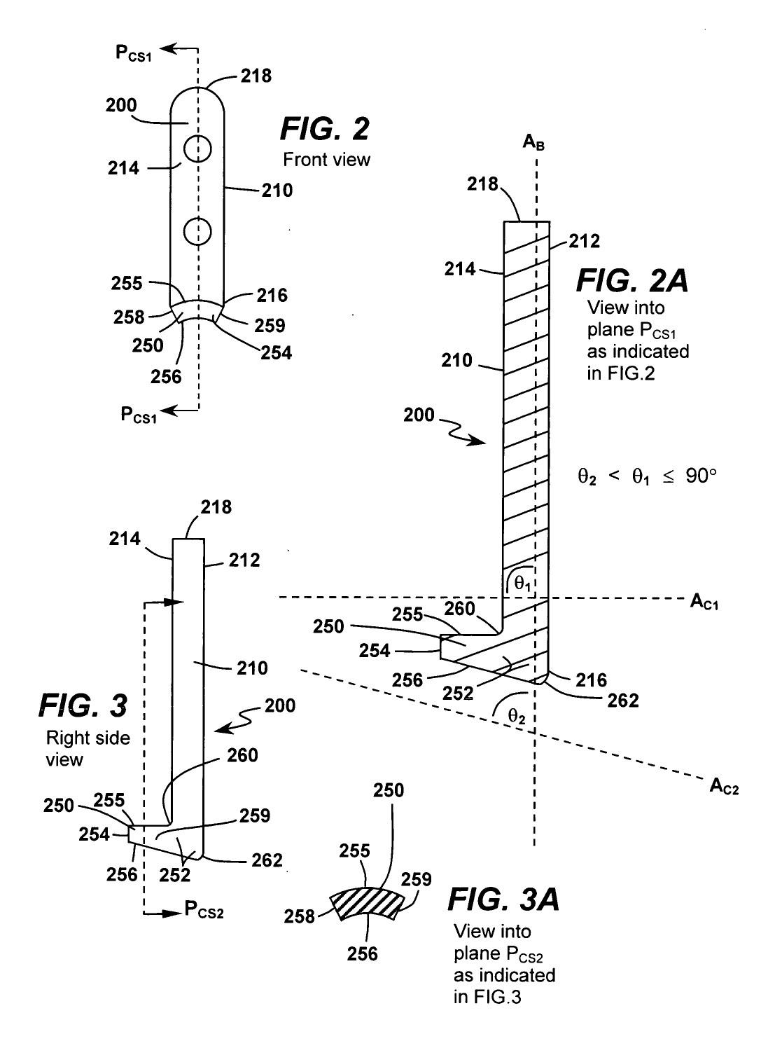

As shown in FIGS. 2 through 3A, depending from the base 210 is a swingbolt catch 250 having base and distal ends 252 and 254 and first and second opposed surfaces 255 and 256. The first surface 255 extends between the front surface 214 of the base 210 and the distal end 254 of the swingbolt catch 250 and is adjacent to, and joined through a first transition region 260 with, the front surface 214 of the base 210. The second surface 256 extends between the rear surface 212 of the base 210 and the distal end 254 of the swingbolt catch 250 and is joined, through a second transition region 262, with the rear surface 212 of the base 210. Moreover, each of the first and second surfaces 255 and 256 extends laterally between left and right sides 258 and 259 of the swingbolt catch 250.

Referring to FIGS. 2 and 2A, as viewed into a first cross-sectional plane P_{CS1} passing through the first and second surfaces 255 and 256, and between the left and right sides 258 and 259, of the swingbolt catch 250, the first and second surfaces 255 and 256 of the swingbolt catch 250 extend along, respectively, first and second catch-surface axes A_{C1} and A_{C2}. The first and second catch-surface axes A_{C1} and A_{C2} converge away from the base 210 such that the swingbolt catch 250 increases in thickness between the first and second surfaces 255 and 256 with increased proximity to the base 210. In various versions, the first catch-surface axis A_{C1} defines, with the base axis A_{B}, a first angle θ₁ that is one of (i) 90-degrees and (ii) acute and the second catch-surface axis A_{C2} defines, with the base axis A_{B} , a second angle θ₂ that is more acute than the first angle θ₁.

Referring to FIGS. 3 and 3A, in order to accommodate the rod 110 of the swingbolt 100, the second surface 256 of the swingbolt catch 250 in some embodiments is concave as viewed into a second cross-sectional plane P_{CS2} passing through the first and second surfaces 255 and 256 and the left and right sides 258 and 259 of the catch 250. Irrespective of the contour of the second surface 256 of the catch 250, some versions include a catch 250 having a convex first surface 255 such as the illustrative versions of FIGS. 2 through 3A.

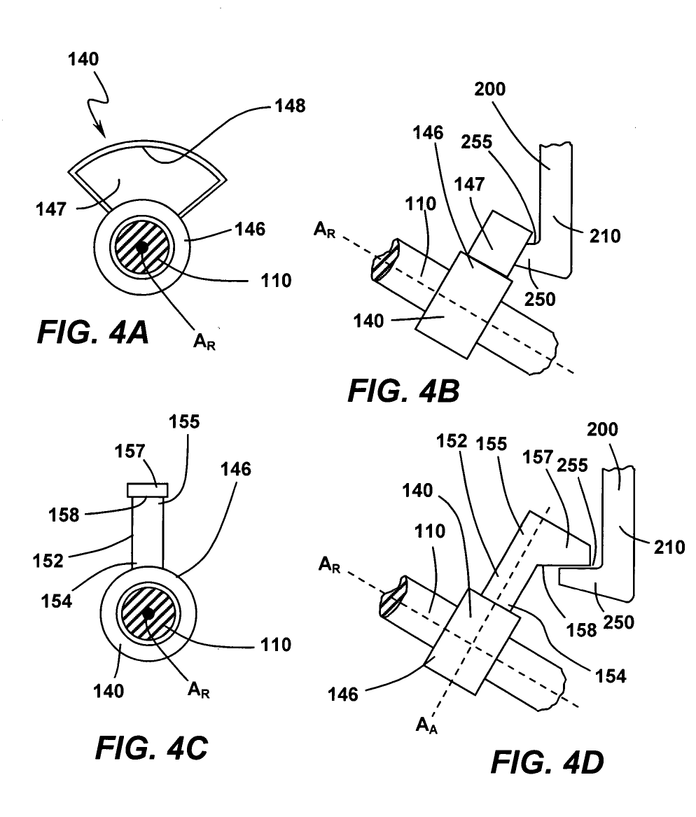

In the particular embodiment of FIG. 1, the hook catch 140 typifies extant swingbolts in that it is in the form of a cup 142 having an interior surface 144 annularly disposed about the rod 110. Although a cup 142 simplifies the coupling of the swingbolt 100 with a swingbolt hook 200 because no particular rotational alignment—about the rod axis A_{R}—of the hook catch 140 with a swingbolt catch 250 is required, it is to be understood that swingbolts having alternatively configured hook catches 140 are within the scope and contemplation of the invention. FIGS. 4A and 4B and 4C and 4D depict non-limiting examples of alternatively configured hook catches 140. FIGS. 4A and 4B depict, respectively, end and side views of a hook catch 140 having a collar 146 annularly disposed about the rod 110. Depending from the collar 146 is a socket 147 having an arcuate interior surface 148 adapted for engaging the first surface 255 of the swingbolt catch 250 of a swingbolt hook 200. FIGS. 4C and 4D depict, respectively, end and side views of a hook catch 140 that, like the example of FIGS. 4A and 4B, includes a collar 146 disposed about the rod 110. Depending from the collar 146 is an arm 152 that extends along an arm axis A_{A} orthogonal to the rod axis A_{R} between collar and distal ends 154 and 155. Extending from the arm 152, in a location more proximate to the distal end 155 than the collar end 154, is a tongue 157 having an interior surface 158 adapted for selective engagement with the first surface 255 of the swingbolt catch 250 of a swingbolt hook 200. The interior surface 158 may, in alternative versions, be planar, concave, keyed for mating with one or more grooves or tongues in the first surface 255 of the swingbolt catch 250 of a hook 200 or otherwise contoured.

In various versions, the catch 250 of a swingbolt hook 200 includes a convex first surface 255 for receiving, for example, (i) the annular interior surface 144 of a cup 142 such as that shown in FIG. 1 or (ii) the arcuate interior surface 148 of a hook catch 140 including a socket 147 with an arcuate interior surface 148 such as that shown in the examples of FIGS. 4A and 4B.

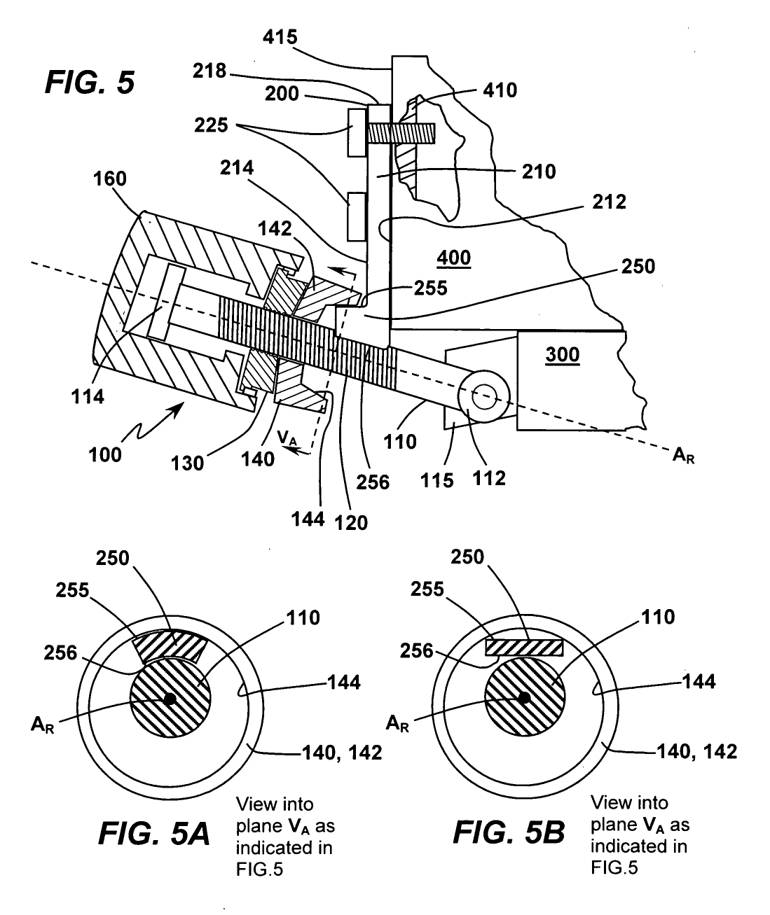

Embodiments of a hook-and-swingbolt fastener system 50 within the scope of the invention are used in substantially the same manner as described in the background section of the specification in connection with an illustrative, previously extant swingbolt fastener system. In light of the previous explanation and in light of the fact that the use of such fastener systems is reasonably apparent, a detailed explanation of the use of an embodiment of a hook-and-swingbolt fastener system 50 embodying aspects of the invention is not provided. However, certain aspects are more fully appreciated by reference to the operative, fastened position of an illustrative embodiment as shown in FIGS. 5 and 5A. As shown in FIG. 5, the illustratively embodied swingbolt hook 200 includes a swingbolt catch 250 having a concave second surface 256 into which, as seen also in the cross-sectional view of FIG. 5A, a portion of the rod 110 is received when the swingbolt 100 and swingbolt hook 200 are cooperatively coupled. Moreover, the convex first surface 255 of the swingbolt catch 250 facilitates contacting engagement with the annular interior surface 144 of the cup 142.

In addition to facilitating engagement between the first surface 255 of the swingbolt catch 250 and the annular or arcuate interior surface 144 or 148 of a hook catch 140 and accommodating a portion of the rod 110, a convex first surface 255 and concave second surface 256 increase the strength of the swingbolt catch 250 relative to alternatively configured swingbolt catches 250. Reference to FIG. 5B facilitates an appreciation for this observation. The swingbolt catch 250 in FIG. 5B is rectangular in cross section and of a maximum width comparable to that of the swingbolt catch 250 in FIG. 5A; in all other respects, the relevant components of the hook-and-swingbolt fastener system 50 of FIG. 5B are the same as those of FIG. 5A. In order to fit into the void between the rod 110 and the interior surface 144 of the cup 142, the swingbolt catch 250 in FIG. 5B is substantially thinner between the first and second surfaces 255 and 256 than the swingbolt catch 250 of FIG. 5A. Moreover, even if as to swingbolt catches 250 of equal thickness, one that is arch-like is stronger than one that is rectangular in cross-section. Accordingly, for a given material, the swingbolt catch 250 of FIG. 5A is stronger than the swingbolt catch of FIG. 5B on both grounds of material thickness and geometry.

As shown in FIG. Bi, swingbolt catches having convex first surfaces and concave second surfaces are not entirely absent from the universe of pre-existing swingbolt hooks. However, swingbolt hooks 200 including features of the present invention embody a third strength-increasing dimension as shown in FIGS. 1, 3A and 5, and explained above in association with FIG. 3A; the rearward sloping of the second surface 256 of the swingbolt catch 250 away from the first catch-surface axis A_{C1} along a second catch-surface axis A_{C2} that extends along, though not necessarily parallel to, the rod axis A_{R} of the swingbolt 100 with which the swingbolt hook 200 is coupled substantially increases the cross-sectional area of material from which the catch is fabricated.

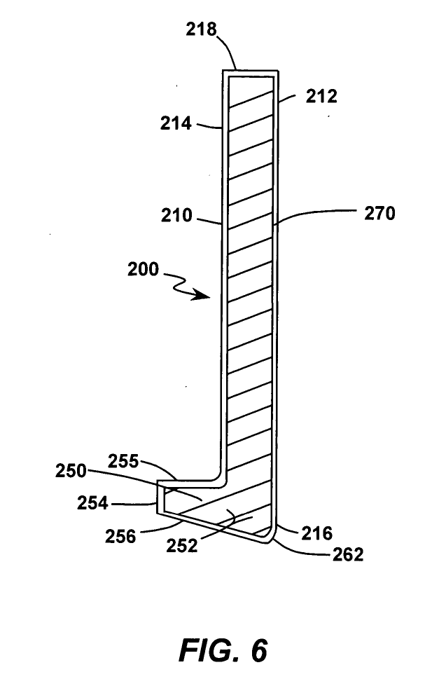

Shown in FIG. 6 is a swingbolt hook 200 including a wear-resistant coating 270. Illustrative, non-limiting examples of suitable wear-resistant coatings include nickel plate, Teflon® and chrome.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact construction, implementations and versions shown and described.

1. A swingbolt hook adapted for cooperative coupling engagement with a swingbolt including (a) an elongated rod having a first end pivotably mountable to a first object and a second end longitudinally opposite the first end, (b) a set of external threads extending along at least a portion of the rod, (c) a hook catch slidably retained by the rod and adapted for longitudinal translation along the rod and (d) an internally threaded nut situated between the second end of the rod and the hook catch such that the nut can be selectively caused to exert a force against the hook catch in the direction of the first end of the rod, the swingbolt hook comprising:
a base having rear and front surfaces and extending along a base axis between first and second ends, the base being adapted for mounting to a second object with the rear surface of the base in contacting engagement with the second object; and
a swingbolt catch adapted for selective retaining engagement with the hook catch of the swingbolt, the swingbolt catch depending from the base and having base and distal ends and first and second opposed surfaces, wherein each of the first and second surfaces extends laterally between left and right sides of the swingbolt catch and wherein (i) the first surface extends between the front surface of the base and the distal end of the swingbolt catch and is adjacent to, and joined through a first transition region with, the front surface of the base and (ii) the second surface extends between the rear surface of the base and the distal end of the swingbolt catch and is joined, through a second transition region, with the rear surface of the base, the first and second surfaces being oriented to one another such that, as viewed into a first cross-sectional plane passing through the first and second surfaces and between the left and right sides of the swingbolt catch, the first and second surfaces extend along, respectively, first and second catch-surface axes that converge away from the base such that the swingbolt catch increases in thickness between the first and second surfaces with increased proximity to the base.

2. The swingbolt hook of claim 1 wherein the first cross-sectional plane includes the base axis and (a) the first catch-surface axis defines, with the base axis, a first angle that is one of (i) 90° and (ii) acute and (b) the second catch-surface axis defines, with the base axis, a second angle that is more acute than the first angle.

3. The swingbolt hook of claim 2 wherein, as viewed into a second cross-sectional plane passing through the first and second surfaces and the left and right sides of the swingbolt catch, at least one of (i) the first surface of the swingbolt catch is convex and (ii) the second surface of the swingbolt catch is concave.

4. The swingbolt hook of claim 1 wherein, as viewed into a second cross-sectional plane passing through the first and second surfaces and the left and right sides of the swingbolt catch, at least one of (i) the first surface of the swingbolt catch is convex and (ii) the second surface of the swingbolt catch is concave.

5. The swingbolt hook of claim 4 wherein at least a portion of the hook includes a wear-resistant coating.

6. The swingbolt hook of claim 2 wherein at least a portion of the hook includes a wear-resistant coating.

7. The swingbolt hook of claim 1 wherein at least a portion of the hook includes a wear-resistant coating.

8. A hook-and-swingbolt fastener system adapted for selectively coupling first and second objects and comprising:
(a) a swingbolt comprising:
(i) an elongated rod having a first end pivotably mountable to a first object and a second end longitudinally opposite the first end,
(ii) a set of external threads extending along at least a portion of the rod,
(iii) a hook catch slidably retained by the rod for longitudinal translation along the rod and having an interior surface, and
(iv) an internally threaded nut situated between the second end of the rod and the hook catch such that the nut can be selectively caused to exert a force against the hook catch in the direction of the first end of the rod; and
(b) a swingbolt hook comprising:
a base having rear and front surfaces and extending along a base axis between first and second ends, the base being adapted for mounting to a second object with the rear surface of the base in contacting engagement with the second object; and
a swingbolt catch adapted for selective retaining engagement with the hook catch of the swingbolt, the swingbolt catch depending from the base and having base and distal ends and first and second opposed surfaces, wherein each of the first and second surfaces extends laterally between left and right sides of the swingbolt catch and wherein (i) the first surface extends between the front surface of the base and the distal end of the swingbolt catch and is adjacent to, and joined through a first transition region with, the front surface of the base and (ii) the second surface extends between the rear surface of the base and the distal end of the swingbolt catch and is joined, through a second transition region, with the rear surface of the base, the first and second surfaces being oriented to one another such that, as viewed into a first cross-sectional plane passing through the first and second surfaces and between the left and right sides of the swingbolt catch, the first and second surfaces extend along, respectively, first and second catch-surface axes that converge away from the base such that the swingbolt catch increases in thickness between the first and second surfaces with increased proximity to the base,
wherein the swingbolt and swingbolt hook cooperate such that, when the interior surface of the hook catch is placed in contacting engagement with the swingbolt catch and the nut is threadably advanced toward the first end of the rod so as to exert at least a predetermined minimum force against the hook catch, the swingbolt catch and hook catch are drawn into retaining engagement.

9. The hook-and-swingbolt fastener system of claim 8 wherein the first cross-sectional plane includes the base axis and (a) the first catch-surface axis defines, with the base axis, a first angle that is one of (i) 90° and (ii) acute and (b) the second catch-surface axis defines, with the base axis, a second angle that is more acute than the first angle.

10. The hook-and-swingbolt fastener system of claim 9 wherein, as viewed into a second cross-sectional plane passing through the first and second surfaces and the left and right sides of the swingbolt catch, at least one of (i) the first surface of the swingbolt catch is convex and (ii) the second surface of the swingbolt catch is concave.

11. The hook-and-swingbolt fastener system of claim 8 wherein, as viewed into a second cross-sectional plane passing through the first and second surfaces and the left and right sides of the swingbolt catch, at least one of (i) the first surface of the swingbolt catch is convex and (ii) the second surface of the swingbolt catch is concave.

12. The hook-and-swingbolt fastener system of claim 11 wherein at least a portion of the hook includes a wear-resistant coating.

13. The hook-and-swingbolt fastener system of claim 9 wherein at least a portion of the hook includes a wear-resistant coating.

14. The hook-and-swingbolt fastener system of claim 8 wherein at least a portion of the hook includes a wear-resistant coating.

15. A hook-and-swingbolt fastener system adapted for releasably mounting an equipment unit housing to a framework carried aboard a transport vehicle, the hook-and-swingbolt fastener system comprising:
(a) a swingbolt comprising:
(i) an elongated rod having a first end pivotably mountable to one of the equipment unit housing and the framework and a second end longitudinally opposite the first end,
(ii) a set of external threads extending along at least a portion of the rod,
(iii) a hook catch slidably retained by the rod for longitudinal translation along the rod and having an interior surface, and
(iv) an internally threaded nut situated between the second end of the rod and the hook catch such that the nut can be selectively caused to exert a force against the hook catch in the direction of the first end of the rod; and
(b) a swingbolt hook comprising:
a base having rear and front surfaces and extending along a base axis between first and second ends, the base being adapted for mounting with the rear surface of the base in contacting engagement with the opposite one of the equipment unit housing and the framework to which the swingbolt is mounted; and
a swingbolt catch adapted for selective retaining engagement with the hook catch of the swingbolt, the swingbolt catch depending from the base and having base and distal ends and first and second opposed surfaces, wherein each of the first and second surfaces extends laterally between left and right sides of the swingbolt catch and wherein (i) the first surface extends between the front surface of the base and the distal end of the swingbolt catch and is adjacent to, and joined through a first transition region with, the front surface of the base and (ii) the second surface extends between the rear surface of the base and the distal end of the swingbolt catch and is joined, through a second transition region, with the rear surface of the base, the first and second surfaces being oriented to one another such that, as viewed into a first cross-sectional plane passing through the first and second surfaces and between the left and right sides of the swingbolt catch, the first and second surfaces extend along, respectively, first and second catch-surface axes that converge away from the base such that the swingbolt catch increases in thickness between the first and second surfaces with increased proximity to the base,
wherein the swingbolt and swingbolt hook cooperate such that, when the interior surface of the hook catch is placed in contacting engagement with the swingbolt catch and the nut is threadably advanced toward the first end of the rod so as to exert at least a predetermined minimum force against the hook catch, the swingbolt catch and hook catch are drawn into retaining engagement and the unit housing is retained by the framework.

16. The hook-and-swingbolt fastener system of claim 15 wherein the transport vehicle by which the framework is carried is one of (i) an ocean-going vessel; (ii) an aircraft and (iii) one of a railroad engine and a railroad car.

17. The hook-and-swingbolt fastener system of claim 16 wherein the first cross-sectional plane includes the base axis and (a) the first catch-surface axis defines, with the base axis, a first angle that is one of (i) 90° and (ii) acute and (b) the second catch-surface axis defines, with the base axis, a second angle that is more acute than the first angle.

18. The hook-and-swingbolt fastener system of claim 17 wherein, as viewed into a second cross-sectional plane passing through the first and second surfaces and the left and right sides of the swingbolt catch, at least one of (i) the first surface of the swingbolt catch is convex and (ii) the second surface of the swingbolt catch is concave.

19. The hook-and-swingbolt fastener system of claim 18 wherein at least a portion of the hook includes a wear-resistant coating.

20. The hook-and-swingbolt fastener system of claim 16 wherein, as viewed into a second cross-sectional plane passing through the first and second surfaces and the left and right sides of the swingbolt catch, at least one of (i) the first surface of the swingbolt catch is convex and (ii) the second surface of the swingbolt catch is concave.
